(19) United States
(12) Patent Application Publication
(10) Pub. No.: US 2022/0327258 A1
(43) Pub. Date: Oct. 13, 2022

(54) EFFICIENT DESIGN AND OPTIMIZATION ALGORITHM FRAMEWORK OF MULTI-SCALE POROUS STRUCTURES

(71) Applicant: DALIAN UNIVERSITY OF TECHNOLOGY, Dalian (CN)

(72) Inventors: Shengfa WANG, Dalian (CN); Jiangbei HU, Dalian (CN); Na LEI, Dalian (CN); Zhongxuan LUO, Dalian (CN)

(21) Appl. No.: 17/841,306

(22) Filed: Jun. 15, 2022

Related U.S. Application Data
(63) Continuation-in-part of application No. 17/349,270, filed on Jun. 16, 2021, now abandoned.

(30) Foreign Application Priority Data
Jul. 28, 2020 (CN) 202010734576.6

(51) Int. Cl. G06F 30/17; G06F 30/23; G06T 17/20

(52) U.S. Cl. CPC G06F 30/17; G06F 30/23; G06T 17/20; G06F 2119/18

(57) ABSTRACT

The present invention relates to an efficient design and optimization algorithm framework of multi-scale porous structures. Firstly, initialized parameters are input by the user to obtain an initial porous structure through the design module. Then, the structure and external physical conditions defined by the user are transmitted to the analysis module to conduct mechanical response analysis of the porous structure. Next, an objective function and constraint functions of the optimization module are defined according to application requirements, and gradient information obtained by the analysis module is input to drive the operation of the optimization module. Finally an optimal multi-scale porous structure is obtained. The present invention relies on a vectorization mode in computer programming, converts a loop problem into a memory storage problem, and benefits from the existing fast computer algorithms for solving a system of linear equations, thus accelerating the calculation process of the whole algorithm.

### TECHNICAL FIELD

The present invention provides an implicit design and optimization algorithm framework of porous structures, which has very high efficiency, and relates to the field of computer-aided design. The present invention can be applied to the fields of medical, biological and engineering design.

### BACKGROUND

Manufacturing structures with light weight and strong mechanical properties has become an important topic in the fields of engineering and biology, which has great challenges and opportunities for development. The porous structures which are widely used has been largely researched. The proposed porous structures, truss structures and honeycomb-like structures have made certain contributions to light-weight work. However, the traditional porous structures have corresponding problems. For example, the honeycomb-like structure and the truss structure will generate stress concentration. And these porous structures must be subjected to physical analysis by the traditional Finite Element Method (FEM) in the process of optimization design, which is time consuming and brings great cost to production and application. Recently, porous structures based on Triply Periodic Minimal Surface (TPMS) have attracted the interest of many researchers in the fields of engineering, biology and chemistry. Such structures have many advantages, like inner fully connected, and having high area-volume ratio, high strength and high stiffness. Among which, the most important advantage is that the porous structures based on TPMS can be generated by functions so that it is favorable for a user to control the pore size and the shell thickness, which brings convenience for efficient optimization design under required objectives and constraints. Moreover, porous structures based on TPMS are suitable for frequently-used 3D printing technologies (SLA, SLS, SLM, FDM and the like). However, the existing design and optimization algorithms for such porous structures are traditional and heuristic, with high complexity and long design period. Therefore an efficient integrated algorithm framework is urgently needed.

The present invention proposes an efficient data-driven automatic optimization framework of porous structures, which comprises design module, analysis module and optimization module. The user can design a multi-scale porous structure with light weight and high mechanical properties by inputting corresponding parameters and external conditions according to application requirements. The structure has continuously changing topological and geometric characteristics according to local mechanical response results. The present invention utilizes the advantage of function representation of TPMS to propose a multi-scale porous structure which can be represented, analyzed, optimized and stored by functions completely based on an implicit design and optimization principle, so that the calculation complexity is greatly reduced. Thus the design and production periods are shortened and the whole process is efficient and robust.

### SUMMARY

Based on the implicit design and optimization method and in combination with the technologies such as computer-aided design and optimal control, the present invention proposes an efficient design and optimization algorithm framework of multi-scale porous structures, which comprises design module, analysis module and optimization module, where these three modules are tightly integrated and completely data-driven: first, initialized parameters are input by a user to obtain an initial porous structure through the design module; then, the structure and external physical conditions defined by the user are transmitted to the analysis module to conduct mechanical response analysis of the structure; next, an objective function and a constraint function of the optimization module are defined according to application requirements, and gradient information obtained by the analysis module is input to drive the operation of the optimization module; and finally an optimal multi-scale porous structure is obtained. A whole design process is shown in FIG. 1.

The technical solution of the present invention is as follows: An efficient design and optimization algorithm framework of multi-scale porous structures, comprising design module, analysis module and optimization module;

(1) Design Module

For a P-surface which is a commonly used Triply Periodic Minimal Surface (TPMS), its implicit function is represented as:

φ_{P}(r)=cos(2π·x)+cos(2π·y)+cos(2π·z)=c (1)

Where r=(x, y, z)∈R³, and c is the value of extracted iso-surface which can control the porosity of the periodic surface;

The multi-scale porous structure is designed based on implicit method: after a geometric parameter c(r)>0 is input into the design module by the user, an implicit function of the multi-scale porous structure is represented as:

ϕ^{s}(r)=min(ϕ₁(r),ϕ₂(r))

ϕ₁(r)=ϕ_{P}(r)+c(r)

ϕ₂(r)=c(r)−ϕ_{P}(r) (2)

The geometric parameter c(r) is a continuous function distribution, which is used to control thickness and obtain a multi-scale porous structure with continuously and gradually changing thickness. The region represented by ϕ^{s}(r)>0 is the interior of the multi-scale porous structure; a topological parameter t(r)>0 is introduced by the user to construct a multi-scale porous structure with a gradually changing pore size, and φ_{P} (r) in formula (2) is rewritten as:

(\tilde{ϕ}_{P}(r)=cos(2π·t(r)·x)+cos(2π·t(r)·y)+cos(2π·t(r)·z) (3)

Therefore, as long as the topological parameter and the geometric parameter are defined by user, a multi-scale porous structure based on TPMS which possesses continuously and gradually changing thickness and pore size can be obtained;

If the user wants to fill a 3D solid model with the multi-scale porous structure based on TPMS, thus to achieve the purpose of light weight, operations shall be carried out according to the function of the multi-scale porous structure of formula (4):

ϕ^{M}=ϕ^{s}∩ϕ^{VDF}=min(ϕ^{s},ϕ^{VDF} (4)

Wherein ϕ^{VDF} is a distance field of the 3D solid model M, and ϕ^{M}≥0 represents the interior of the model filled with the multi-scale porous structure; an iso-surface of the function of the multi-scale porous structure is extracted by a Marching Cube algorithm to obtain an explicit triangle mesh representation of the multi-scale porous structure;

Topological structure of the multi-scale porous structure is controlled by the topological parameter t(r), and the thickness is controlled by the geometric parameter c(r);

Geometric parameter: according to the linear relationship among the geometric parameter, the topological parameter and the thickness, the value range of the geometric parameter c(r) is set as

$$[ \frac{{ω}_{min} {t}_{0}}{0.1838} , 0.8 ] ,$$

where ωₘᵢₙ is the default value of the minimum printing accuracy, and t₀=1 is the initial topological parameter;

Topological parameter:

$${c}_{0} = ( \frac{{ω}_{min} {t}_{0}}{0.1838} + 0 \text{.8} ) / 2$$

is given, and then the value range of the topological parameter is

$$t ( r ) ∈ ( 0 , \frac{0.8 {t}_{0}}{{c}_{0}} ) ,$$

where t₀=1 is the initial topological parameter; During the design process of the multi-scale porous structure, the topological parameter t(r) influences the thickness of the multi-scale porous structure. Therefore, according to the linear relationship among the geometric parameter, the topological parameter and the thickness, formula (2) is modified in the process of topological optimization to fix the shell thickness:

$${ϕ}_{1} ( r ) = {\tilde{φ}}_{P} ( r ) + \tilde{c} ( r ) {ϕ}_{2} ( r ) = \tilde{c} ( r ) - {\tilde{φ}}_{P} ( r ) \tilde{c} ( r ) = {c}_{0} ( r ) \frac{t ( r )}{{t}_{0} ( r )} \qquad ( 5 )$$

Wherein \tilde{c}(r) is a modified geometric parameter used to eliminate the influence of the topological parameter on the thickness, so as to ensure that the thickness is always unchanged in the process of topological optimization;

(2) Analysis Module

The analysis module is a meshless analysis method. Firstly, the design domain of the multi-scale porous structure is divided into an uniform primary elements set, and then divide each primary element uniformly into secondary elements set of the same size, where the primary elements set is used to interpolate the deformation field, and the secondary elements sets is used to represent the model. That is, after the function ϕ_{M} of the multi-scale porous structure is obtained by the design module, the values of the function of the multi-scale porous structure at all secondary element nodes can be calculated, where the value greater than 0 indicates that this node is inside the multi-scale porous structure, the value equal to 0 indicates that this node is on the boundary of the multi-scale porous structure, and the value less than 0 indicates that this node is outside the multi-scale porous structure; next, integral calculus of the stress function, strain function and deformation function on the multi-scale porous structure can be completed. Finally, a form of the problem to be solved is:

KU=F (6)

Wherein U is deformation vector; F is nodal force vector which is obtained according to the external load defined by the user; and K is global stiffness matrix;

(3) Optimization Module

On the basis of the analysis module, optimal solutions of the parameters of the multi-scale porous structure can be obtained according to the results of the mechanical response analysis to achieve the maximum stiffness of the multi-scale porous structure with required material consumption limitation, thus to achieve the purpose of light weight. The problem formulation of the optimization module is constructed by taking structural compliance minimization as the objective and taking model volume and gradient of pore size distribution as constraints:

$${min}_{c ( r ) , t ( r )} I = {F}^{T} U \qquad ( 7 )$$

$$Thus$$

$$KU = F V = \frac{1}{8} {\sum }_{j = 1}^{{N}_{b}} {\sum }_{l = 1}^{8} {H}_{η} ( {ϕ}_{l}^{j} ) {v}_{b} \leq \overline{V} G = \frac{1}{‖ {Ω}_{M} ‖} {\sum }_{{j = 1}^{}}^{{N}_{b}} {\sum }_{l = 1}^{8} ℏ ( \frac{‖ ∇ {t}_{l} ‖}{\overline{g}} ) {v}_{b} \leq 1 \qquad ( 8 )$$

Where I is structural compliance of the model, U is the deformation vector, F is the nodal force vector, K is the global stiffness matrix, V is the volume fraction, V̅ is the designated volume constraint, ϕₗ^{j} is the value of ϕ^{s} at the l^{th} node of the j^{th} secondary element, G is the distribution gradient of the topological parameter, g̅ is the designated gradient constraint value, v_{b} is the volume of the secondary element, N_{b} is the number of the total secondary elements in a solution domain, ∥∇tₗ∥ is the value of a periodic distribution gradient ∥∇t(r)∥ at the l^{th} node of the j^{th} secondary element, and ∥Ω_{M}∥ is the volume of the design domain; and H_{η}(x) is a regularized Heaviside function:

$${H}_{η} ( x ) = \{ \begin{matrix}1 , if x > η , \\ \frac{3 ( 1 - α )}{4} ( \frac{x}{η} - \frac{{x}^{3}}{3 {η}^{2}} ) + \frac{1 + α}{2} , if - η \leq x \leq η , \\ α , if x < - η ,\end{matrix} \qquad ( 9 )$$

where η is used to control the degree of regularization, whose value is 2 times the mesh accuracy of the secondary elements; α=0.01 is used to ensure the nonsingularity of the global stiffness matrix; and ℏ(x) is defined as follows:

$$ℏ ( x ) = \{ \begin{matrix}{( x - 1 )}^{2} + 1 , & if x \geq 1 \\ 1 , & if x < 1\end{matrix} \qquad ( 10 )$$

Optimization Process

For the problem formulation of the optimization module, it is only required to optimize the geometric parameters and topological parameters driven by the calculation results of the analysis module. During the optimization process, t(r) is optimized firstly to determine the topological shape of the porous structure, and then c(r) is optimized to determine the thickness of the porous structure. Therefore the whole optimization process is divided into topological optimization and geometric optimization, and the process is as follows:

Step 1: Topological Optimization

Interpolating the topological parameter t(r) by radial basis function interpolation method and converting the optimization of the function into the optimization of the parameters at interpolation nodes. Randomly selecting interpolation points {pᵢ}ᵢ₌₁ⁿ^{ᵣ}∈Ω_{M} in the design domain Ω_{M}, so that the form of interpolation of the topological parameter t(r) is:

$$t ( r ) = {\sum }_{i = 1}^{{n}_{r}} {R}_{i} ( r ) {a}_{i}^{t} + {\sum }_{j = 1}^{m} {q}_{j} ( r ) {b}_{j}^{t} \qquad ( 11 )$$

Where Rᵢ(r)=R(∥r−pᵢ∥), R(x)=x² log(|x|) is logarithmic radial basis function, {qⱼ(r)} is a polynomial of coordinates, and aᵢ^{t} and bᵢ^{t} are undetermined coefficients. Formula (10) is simplified through derivation as:

$$t ( r ) = {\sum }_{i = 1}^{{n}_{r}} {S}_{i} ( r ) {t}_{i} \qquad ( 12 )$$

Where tᵢ=t(pᵢ) is the periodic value at the control point pᵢ, and Sᵢ(r) is the polynomial form derived from matritization. Thus, the topological optimization of the porous structure is converted into the optimization of parameters {tᵢ}ᵢ₌₁ⁿ^{ᵣ};

Finally, calculating the derivatives of the objective function and the constraint function about optimization variables to obtain sensitivity information of the variables as follows:

$$\frac{\partial I}{\partial {t}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {t}_{i}} ) {K}^{0} ) {U}_{k} \frac{\partial V}{\partial {t}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {t}_{i}} {v}_{b} \frac{\partial G}{\partial {t}_{i}} = \frac{1}{‖ {Ω}_{M} ‖} {\sum }_{j = 1}^{{N}_{b}} {\sum }_{l = 1}^{8} {ℏ}^{′} ( \frac{‖ ∇ {t}_{l} ‖}{\overline{g}} ) \frac{\partial ‖ ∇ t ‖}{\partial {t}_{i}} {v}_{b} \qquad ( 13 )$$

wherein Nₛ, is the number of the primary elements, N_{b} is the number of the total secondary elements in the design domain, Uₖ is the node deformation vector corresponding to the k^{th} element, K⁰=E₀B^{T}D⁰Bv_{b}, E₀ is the modulus of elasticity, B is the strain matrix, D⁰ is the constitutive matrix of the elements filled by solid material, ϕₗ^{ij} is the value of ϕ^{s} at the l^{th} node of the j^{th} secondary element in the i^{th} primary element. Then, the sensitivity information is substituted into the Method of Moving Asymptotes (MMA) solver to obtain the solution of the problem under topological optimization, i.e., the value of an optimal parameter {tᵢ}ᵢ₌₁ⁿ^{ᵣ}. As a result, the topological shape of the multi-scale porous structure is determined;

Step 2: Geometric Optimization

Geometric optimization is the optimization of the geometric parameter c(r) The optimization of the function can be converted into the optimization of parameter {cᵢ}ᵢ₌₁ⁿ^{ᵣ} at the control points. After randomly selecting interpolation points {pᵢ}ᵢ₌₁ⁿ^{ᵣ}∈Ω_{M} in the design domain Ω_{M}, the geometric parameter c(r) can be interpolated as:

$$c ( r ) = {\sum }_{i = 1}^{{n}_{r}} {R}_{i} ( r ) {a}_{i}^{c} + {\sum }_{j = 1}^{m} {q}_{j} ( r ) {b}_{j}^{c} \qquad ( 14 )$$

where aᵢ^{c} and bⱼ^{c} are undetermined coefficients. as the interpolation form can be simplified as:

$$c ( r ) = {\sum }_{i = 1}^{{n}_{r}} {S}_{i} ( r ) {c}_{i} \qquad ( 15 )$$

Where cᵢ=c(pᵢ) is the thickness value at the control point pᵢ, and Sᵢ(r) is a polynomial form derived through matritization. Then, the sensitivity information about the optimization variables is calculated and substituted into the MMA solver to obtain the solution of the problem under geometric optimization;

$$\frac{\partial I}{\partial {c}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {c}_{i}} ) {K}^{0} ) {U}_{k} \frac{\partial V}{\partial {c}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {c}_{i}} {v}_{b} \qquad ( 16 )$$

Driven by the data output from the analysis module, the structure parameters in the design module can be optimized automatically. And finally the multi-scale porous structure with the maximum stiffness is obtained.

The present invention belongs to a modeling and optimization system in the field of computer-aided design, which designs and manufactures the internal porous filling structure of the 3D solid model for the needs of 3D printing and industrial production. The present invention proposes a new efficient algorithm framework for representation domain optimization of the porous structure, which comprises design module, analysis module and optimization module, where these three modules are tightly integrated and completely data-driven. The present invention relies on a vectorization mode in computer programming, converts a loop problem into a memory storage problem, and benefits from the existing fast computer algorithms for solving a system of linear equations, thus accelerating the calculation process of the whole algorithm. This framework has high efficiency and robust algorithm performance. The designed multi-scale porous structure can be described, analyzed, optimized and stored completely by functions. The present invention has low calculation complexity and high efficiency, greatly shortens the design and optimization periods of the porous structure, and can meet the requirements of industrial production to provide an optimal result. Moreover, the porous structure based on TPMS has many advantages such as smoothness (facilitating force and heat transfer in industry, and cell adhesion in biology), full connectivity (capable of exporting the waste generated by printing in the process of 3D printing and facilitating cell migration in biology), easy control (capable of arbitrarily changing the shape of the structure by controlling the parameters of the functions), quasi self-support (saving material), and the like. These properties allow the porous structures based on TPMS to have great applicability and development space in the fields of industry and biology.

### DESCRIPTION OF DRAWINGS

FIG. 1 is a flow chart of a design and optimization algorithm framework of multi-scale porous structures.

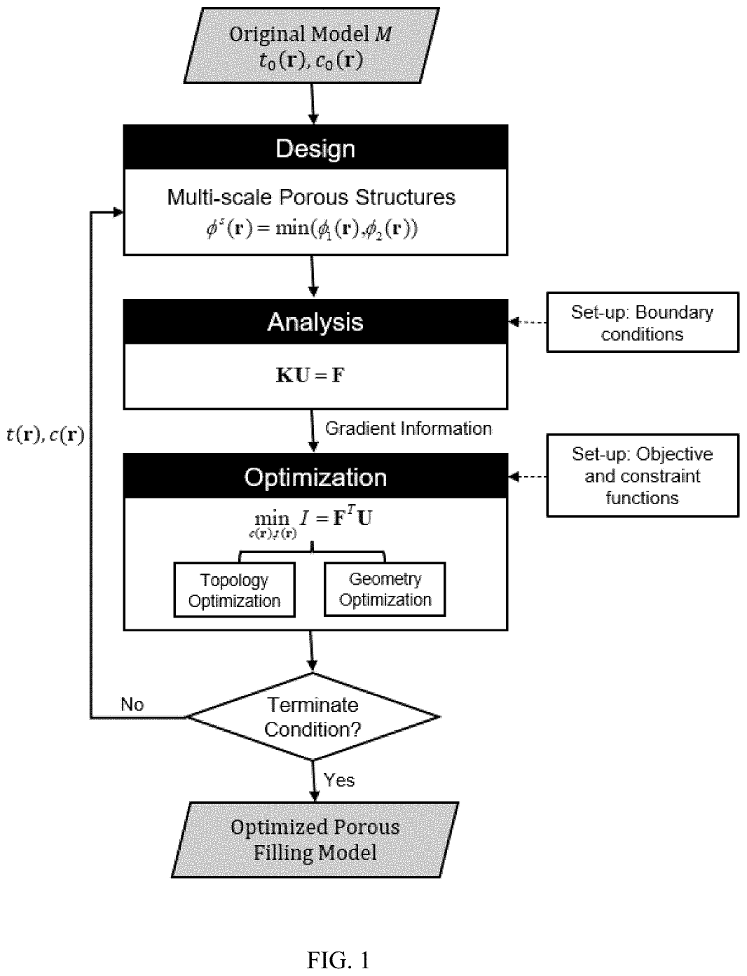

FIG. 2 is a diagram of optimization results and printing models filled with the multi-scale porous structures.

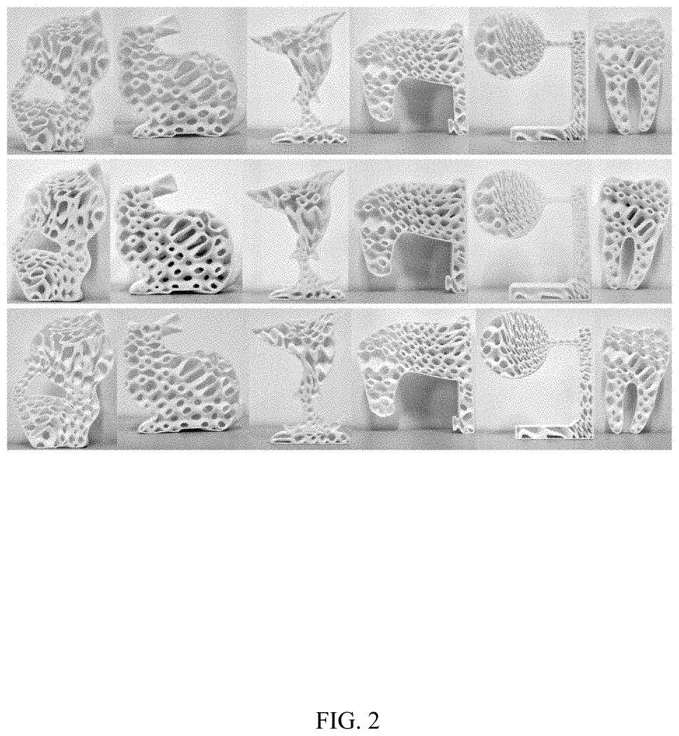

### DETAILED DESCRIPTION

A specific embodiment of the present invention is a process to finally obtain an optimal multi-scale porous structure based on data flow transmission in the design module, analysis module and optimization module. The main steps are as follows:

Step 1: Initialization

A user designating a type of Triply Periodic Minimal Surface (TPMS) (taking a P-surface as an example here) and conducting sampling in the design domain. Then initializing values of the geometric parameters and topological parameters at sampling points to obtain {tᵢ⁰}ᵢ₌₁ⁿ^{ᵣ} and {cᵢ⁰}ᵢ₌₁ⁿ^{ᵣ} (reference values: the user can set tᵢ⁰≡1 and cᵢ⁰≡0.2), thus continuous geometric parameters distribution and topological parameters distribution can be obtained by radial basis function (RBF) interpolation:

$${t}^{0} ( r ) = {\sum }_{i = 1}^{{n}_{r}} {S}_{i} ( r ) {t}_{i}^{0} \qquad ( 18 )$$

$${c}^{0} ( r ) = {\sum }_{i = 1}^{{n}_{r}} {S}_{i} ( r ) {c}_{i}^{0} \qquad ( 19 )$$

Then an initial porous surface can be constructed:

\tilde{φ}_{P}(r)=cos(2π·t⁰(r)·x)+cos(2π·t⁰(r)·y)+cos(2π·t⁰(r)·z) (20)

Further constructing a porous structure with thickness:

$${ϕ}^{s} ( r ) = min ( {ϕ}_{1} ( r ) , {ϕ}_{2} ( r ) ) \qquad ( 21 )$$

$${ϕ}_{1} ( r ) = {\tilde{φ}}_{P} ( r ) + \tilde{c} ( r ) \qquad ( 22 )$$

$$\begin{matrix}{ϕ}_{2} ( r ) = \tilde{c} ( r ) - {\tilde{φ}}_{P} ( r ) & ( 23 ) \\ \tilde{c} ( r ) = {c}_{0} ( r ) \frac{t ( r )}{{t}_{0} ( r )} & ( 24 )\end{matrix}$$

where ϕ^{s}(r)>0 represents the region defined as Ωₛ, i.e., the interior of a porous shell structure based on TPMS.
For a model M to be filled, representing the model filled with the porous structure by a function:

ϕ_{M}=ϕₛ∩ϕ_{MDF}=min(ϕ^{s},ϕ_{MDF})

Then ϕ^{M}≥0 represents the interior of the model filled with the porous structure.

Step 2: Analysis

The user designating boundary conditions such as an external load and a fixed point for the model and application practices. Dividing the design domain roughly into a primary elements set, and then dividing each primary element uniformly into secondary unit elements. Using the primary elements set to interpolate a deformation field, using the secondary elements set to represent the model and calculating integral calculus. Constructing local stiffness matrices of all primary elements, and then integrating the local stiffness matrices into a global stiffness matrix K, thus the corresponding physical problem model can be obtained:

KU=F (25)

wherein U is deformation vector, i.e., the quantity to be solved; and F is nodal force vector which is obtained according to the boundary conditions designated by the user. After the deformation field is obtained, physical quantities such as strain energy and an equivalent stress field which can reflect mechanical properties of the structure can be further solved.

Step 3: Optimization

The present invention can optimize the parameters of the multi-scale porous structure by taking structural compliance minimization as an objective and taking model volume and gradient of pore size distribution as constraints. After mechanical response analysis of the structure is completed by step 2, gradient information of objective function and constraint functions about the geometric parameter {cᵢ⁰}ᵢ₌₁ⁿ^{ᵣ} and the topological parameter {tᵢ⁰}ᵢ₌₁ⁿ^{ᵣ} can be obtained:

$$\frac{\partial I}{\partial {t}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {t}_{i}} ) {K}^{0} ) {U}_{k} \qquad ( 26 )$$

$$\frac{\partial V}{\partial {t}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {t}_{i}} {v}_{b} \qquad ( 27 )$$

$$\frac{\partial G}{\partial {t}_{i}} = \frac{1}{‖ {Ω}_{M} ‖} {\sum }_{j = 1}^{{N}_{b}} {\sum }_{l = 1}^{8} {ℏ}^{′} ( \frac{‖ ∇ {t}_{l} ‖}{\overline{g}} ) \frac{\partial ‖ ∇ t ‖}{\partial {t}_{i}} {v}_{b} \qquad ( 28 )$$

$$\begin{matrix}\frac{\partial I}{\partial {c}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{{k}_{j}} )}{\partial {c}_{i}} ) {K}^{0} ) {U}_{k} & ( 29 ) \\ \frac{\partial V}{\partial {c}_{i}} = \frac{1}{8} {\sum }_{j = 1}^{{N}_{b}} {\sum }_{l = 1}^{8} \frac{\partial {H}_{η} ( {ϕ}_{i}^{j} )}{\partial {c}_{i}} {v}_{b} & ( 30 )\end{matrix}$$

Transmitting the gradient information to a Method of Moving Asymptotes (MMA) solver based on gradient, the new geometric parameters and the new topological parameters can be obtained. Then, transmitting the parameters to the design module in step 1 to construct the new porous structure. Next, conducting analysis and repeating the above steps until parameter change is less than a threshold value and a termination condition is reached. As a result, an optimal parametric solution can be obtained. The multi-scale porous structure produced is the structure with maximum stiffness under a constrained volume, and finally the purpose of light weight is achieved.

The present invention proposes a new efficient algorithm framework for representation domain optimization of the porous structure, which comprises design module, analysis module and optimization module, where these three modules are tightly integrated and completely data-driven. The present invention relies on a vectorization mode in computer programming, converts a loop problem into a memory storage problem, and is based on the existing fast computer algorithms for solving a system of linear equations, thus accelerating the calculation process of the whole algorithm, which has high efficiency and robust algorithm performance. The present invention conducts experiments on many different 3D models and uses different types of TPMS to design the porous structure. An optimization model with high strength under the constrained volume can be obtained by the experimental results. The porous structure obtained by the experiments is observed. It can be found that under stress circumstances, an area with a large stress in the model has a small pore size and a large thickness, and mass is concentrated in this area. In contrast, an area with a small stress has a large pore size and a small thickness. Under a gradient constraint, the transition between pores of different sizes is natural, and no stress concentration part is generated. To describe high efficiency of the present invention, the time complexity of the algorithm is compared with the general mechanical analysis software ANSYS. Through comparison, it is found that the time for conducting the physical analysis in the present invention is several tenths of or even a few hundredths of the time of ANSYS, which fully demonstrates the high efficiency of the present invention. At the same time, the results of mechanical analysis are also compared with ANSYS in accuracy. The experiment can show that the present invention can also meet the manufacturing requirements in the calculation accuracy.

1. An efficient design and optimization algorithm framework of multi-scale porous structures, comprising a design module, an analysis module and an optimization module; the three modules are driven by data and integrated into a computer program to get optimized multi-scale porous structures: first, initialized parameters are input by a user to obtain an initial multi-scale porous structure through the design module; then, the multi-scale porous structure and external physical conditions defined by the user are transmitted to the analysis module to conduct mechanical response analysis of the multi-scale porous structure; next, an objective function and a constraint function of the optimization module are defined according to application requirements, and gradient information obtained by the analysis module is input to drive the operation of the optimization module; and finally an optimal multi-scale porous structure is obtained; the specific process is as follows:
(1) design module
for a P-surface which is a commonly used Triply Periodic Minimal Surface (TPMS), an implicit function of the P-surface is represented as:
φ_{P}(r)=cos(2π·x)+cos(2π·y)+cos(2π·z)=c (31)
wherein r=(x, y, z)∈R³, and c is a value of extracted an iso-surface which controls porosity of a periodic surface;
the multi-scale porous structure is designed based on an implicit method: after a geometric parameter c(r)>0 is input into the design module by the user, an implicit function of the multi-scale porous structure is represented as:
ϕ^{s}(r)=min(ϕ₁(r),ϕ₂(r))
ϕ₁(r)=ϕ_{P}(r)+c(r)
ϕ₂(r)=c(r)−ϕ_{P}(r) (32)
the geometric parameter c(r) is a continuous function distribution, which is used to control thickness and obtain a multi-scale porous structure with a continuously and gradually changing thickness; a region represented by ϕ^{s}(r)>0 is the interior of the multi-scale porous structure; a topological parameter t(r)>0 is introduced by the user to construct a multi-scale porous structure with a gradually changing pore size, and φ_{P} (r) in formula (2) is rewritten as:
\tilde{φ}_{P}(r)=cos(2π·t(r)·x)+cos(2π·t(r)·y)+cos(2π·t(r)·z) (33)
therefore, as long as the topological parameter and the geometric parameter are defined by user, a multi-scale porous structure based on TPMS which possesses continuously and gradually changing thickness and pore size can be obtained;
if the user wants to fill a 3D solid model with the multi-scale porous structure based on TPMS, thus to achieve the purpose of light weight, operations shall be carried out according to a function of the multi-scale porous structure of formula (4):
ϕ^{M}=ϕ^{s}∩ϕ^{VDF}=min(ϕ^{s},ϕ^{VDF} (34)
wherein ϕ^{VDF} is a distance field of the 3D solid model M, and ϕ^{M}≥0 represents the interior of the model filled with the multi-scale porous structure; an iso-surface of the function of the multi-scale porous structure is extracted by a Marching Cube algorithm to obtain an explicit triangle mesh representation of the multi-scale porous structure;
a topological structure of the multi-scale porous structure is controlled by the topological parameter t(r), and the thickness is controlled by the geometric parameter c(r);
the geometric parameter: according to the linear relationship among the geometric parameter, the topological parameter and the thickness, the value range of the geometric parameter c(r) is set as
$$[ \frac{{ω}_{min} {t}_{0}}{0.1838} , 0.8 ] ,$$
wherein ωₘᵢₙ is the default value of the minimum printing accuracy, and t₀=1 is an initial topological parameter;
the topological parameter
$${c}_{0} = ( \frac{{ω}_{min} {t}_{0}}{0.1838} + 0.8 ) / 2$$
is given, and then the value range of the topological parameter is
$$t ( r ) ∈ ( 0 , \frac{0.8 {t}_{0}}{{c}_{0}} ) ,$$
wherein t₀=1 is an initial topological parameter; during the design process of the multi-scale porous structure, the topological parameter t(r) influences the thickness of the multi-scale porous structure therefore, according to the linear relationship among the geometric parameter, the topological parameter and the thickness, formula (2) is modified in the process of topological optimization to fix the shell thickness:
$${ϕ}_{1} ( r ) = {\tilde{φ}}_{P} ( r ) + \tilde{c} ( r ) {ϕ}_{2} ( r ) = \tilde{c} ( r ) - {\tilde{φ}}_{P} ( r ) \tilde{c} ( r ) = {c}_{0} ( r ) \frac{t ( r )}{{t}_{0} ( r )} \qquad ( 35 )$$
wherein \tilde{c}(r) is a modified geometric parameter used to eliminate the influence of the topological parameter on the thickness, so as to ensure that the thickness is always unchanged in the process of topological optimization;
(2) analysis module
the analysis module is a meshless analysis method, a design domain of the multi-scale porous structure is divided into an uniform primary elements set, and then divide each primary element uniformly into secondary elements set of the same size, wherein the primary elements set is used to interpolate a deformation field, and the secondary elements set is used to represent the model; the specific method is as follows: the function ϕ^{M} of the multi-scale porous structure is obtained by the design module; then, values of the function of the multi-scale porous structure at all secondary element nodes are calculated, wherein a value greater than 0 indicates that a node is inside the multi-scale porous structure, a value equal to 0 indicates that a node is on the boundary of the multi-scale porous structure, and a value less than 0 indicates that a node is outside the multi-scale porous structure; next, integral calculus of a stress function, a strain function and a deformation function on the multi-scale porous structure is completed; and finally, a form of a problem to be solved is:
KU=F (36)
wherein U is a deformation vector; F is a nodal force vector which is obtained according to an external load defined by the user; and K is a global stiffness matrix;
(3) optimization module
on the basis of the analysis module, optimal solutions of the parameters of the multi-scale porous structure are obtained according to the results of the mechanical response analysis to achieve the maximum stiffness of the multi-scale porous structure with required material consumption limitation, thus to achieve the purpose of light weight; a problem formulation of the optimization module is constructed by taking structural compliance minimization as an objective and taking model volume and gradient of pore size distribution as constraints:
$${min}_{c ( r ) , t ( r )} I = {F}^{T} U \\ thus \qquad ( 37 )$$
$$KU = F V = \frac{1}{8} {\sum }_{j = 1}^{{N}_{b}} {\sum }_{l = 1}^{8} {H}_{η} ( {ϕ}_{l}^{j} ) {v}_{b} \leq \overline{V} G = \frac{1}{‖ {Ω}_{M} ‖} {\sum }_{j = 1}^{{N}_{b}} {\sum }_{l = 1}^{8} ℏ ( \frac{‖ ∇ {t}_{l} ‖}{\overline{g}} ) {v}_{b} \leq 1 \qquad ( 38 )$$
wherein I is structural compliance of the model, U is the deformation vector, F is the nodal force vector, K is the global stiffness matrix, V is a volume fraction, V̅ is a designated volume constraint, ϕₗ^{j} is a value of ϕ^{s} at the l^{th} node of the j^{th} secondary element, G is a periodic distribution gradient, g̅ is a designated gradient constraint value, v_{b} is the volume of the secondary element, N_{b} is the number of the total secondary elements in a solution domain, ∥∇tₗ∥ is a value of a periodic distribution gradient ∥∇t(r)∥ at the l^{th} node of the j^{th} secondary element, and ∥Ω_{M}∥ is the volume of the design domain; and H_{η}(x) is a regularized Heaviside function:
$${H}_{η} ( x ) = \{ \begin{matrix}1 , & if x > η , \\ \frac{3 ( 1 - α )}{4} ( \frac{x}{η} - \frac{{x}^{3}}{3 {η}^{2}} ) + \frac{1 + α}{2} , & if - η \leq x \leq η , \\ α , & if x < - η ,\end{matrix} \qquad ( 39 )$$
wherein η is used to control the degree of regularization, whose value is 2 times the mesh accuracy of the secondary elements; α=0.01 is used to ensure the nonsingularity of the global stiffness matrix; and ℏ(x) is defined as follows:
$$ℏ ( x ) = \{ \begin{matrix}{( x - 1 )}^{2} + 1 , & if x \geq 1 \\ 1 , & if x < 1\end{matrix} \qquad ( 40 )$$
optimization process
for the problem formulation of the optimization module, it is only required to optimize the geometric parameters and topological parameters driven by the calculation results of the analysis module; during the optimization process, t(r) is optimized firstly to determine the topological shape of the porous structure, and then c(r) is optimized to determine the thickness of the porous structure, therefore the whole optimization process is divided into topological optimization and geometric optimization, and the process is as follows:
step 1: topological optimization
interpolating the topological parameter t(r) by a radial basis function interpolation method and converting the optimization of the function into the optimization of the parameter at an interpolation nodes; randomly selecting an interpolation points {pᵢ}ᵢ₌₁ⁿ^{ᵣ}∈Ω_{M} in the design domain Ω_{M}, so that the form of interpolation of the topological parameter t(r) is:
$$t ( r ) = {\sum }_{i = 1}^{{n}_{r}} {R}_{i} ( r ) {a}_{i}^{t} + {\sum }_{j = 1}^{m} {q}_{j} ( r ) {b}_{j}^{t} \qquad ( 41 )$$
wherein Rᵢ(r)=R(∥r−pᵢ∥), R(x)=x² log(|x|) is logarithmic radial basis function, {qⱼ(r)} is a polynomial of coordinates, and aᵢ^{t} and bⱼ^{t} are undetermined coefficients; formula (10) is simplified through derivation as:
$$t ( r ) = {\sum }_{i = 1}^{{n}_{r}} {S}_{i} ( r ) {t}_{i} \qquad ( 42 )$$
wherein tᵢ=t(pᵢ) is a periodic value at a control point pᵢ, and Sᵢ(r) is a polynomial form derived from matritization; thus, the topological optimization of the porous structure is converted into the optimization of parameters {tᵢ}ᵢ₌₁ⁿ^{ᵣ};
finally, calculating derivatives of the objective function and the constraint function about optimization variables to obtain sensitivity information of the variables as follows:
$$\frac{\partial l}{\partial {t}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {t}_{i}} ) {K}^{0} ) {U}_{k} \frac{\partial V}{\partial {t}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {t}_{i}} {v}_{b} \frac{\partial G}{\partial {t}_{i}} = \frac{1}{‖ {Ω}_{M} ‖} {\sum }_{j = 1}^{{N}_{b}} {\sum }_{l = 1}^{8} {ℏ}^{′} ( \frac{‖ ∇ {t}_{l} ‖}{\overline{g}} ) \frac{\partial ‖ ∇ t ‖}{\partial {t}_{i}} {v}_{b} \qquad ( 43 )$$
wherein Nₛ is the number of the primary elements, N_{b} is the number of the total secondary elements in the design domain, Uₖ is a node deformation vector corresponding to the k^{th} element, K⁰=E₀B^{T}D⁰Bv_{b}, E₀ is a modulus of elasticity, B is a strain matrix, D⁰ is a constitutive matrix of the elements filled by solid material, ϕₗ^{ij} is a value of ϕ^{s} at the l^{th} node of the j^{th} secondary element in the i^{th} primary element; then, the sensitivity information is substituted into a Method of Moving Asymptotes (MMA) solver to obtain the solution of the problem under topological optimization, i.e., the value of an optimal parameter {tᵢ}ᵢ₌₁ⁿ^{ᵣ}; As a result, a topological shape of the multi-scale porous structure is determined;
step 2: geometric optimization
geometric optimization is the optimization of the geometric parameter c(r); the optimization of the function is converted into the optimization of parameter {cᵢ}ᵢ₌₁ⁿ^{ᵣ} at the control points; after randomly selecting an interpolation points {pᵢ}ᵢ₌₁ⁿ^{ᵣ}∈Ω_{M} in the design domain Ω_{M}, the geometric parameter c(r) is interpolated as:
$$c ( r ) = {\sum }_{i = 1}^{{n}_{r}} {R}_{i} ( r ) {a}_{i}^{c} + {\sum }_{j = 1}^{m} {q}_{j} ( r ) {b}_{j}^{c} \qquad ( 44 )$$
wherein aᵢ^{c} and bⱼ^{c} are undetermined coefficients, the interpolation form can be simplified as:
$$c ( r ) = {\sum }_{i = 1}^{{n}_{r}} {S}_{i} ( r ) {c}_{i} \qquad ( 45 )$$
wherein cᵢ=c(pᵢ) is a thickness value at the control point pᵢ, and Sᵢ(r) is a polynomial form derived through matritization; then, the sensitivity information about the optimization variables is calculated and substituted into the MMA solver to obtain the solution of the problem under geometric optimization;
$$\frac{\partial I}{\partial {c}_{i}} = - {\sum }_{k = 1}^{{N}_{s}} {U}_{k}^{T} ( \frac{1}{8} {\sum }_{j = 1}^{{N}_{b}} ( {\sum }_{l = 1}^{8} \frac{\partial {H}_{η} ( {ϕ}_{l}^{kj} )}{\partial {c}_{i}} ) {K}^{0} ) {U}_{k} \qquad ( 46 )$$
$$\frac{\partial V}{\partial {c}_{i}} = \frac{1}{8} {\sum }_{j = 1}^{{N}_{b}} {\sum }_{l = 1}^{8} \frac{\partial {H}_{η} ( {ϕ}_{l}^{j} )}{\partial {c}_{i}} {v}_{b} \qquad ( 47 )$$
driven by the data output from the analysis module, the structure parameters in the design module is optimized automatically, and finally the multi-scale porous structure with the maximum stiffness is obtained.
